(19) United States
(12) Patent Application Publication
(10) Pub. No.: US 2005/0099939 A1
(43) Pub. Date: May 12, 2005

(54) Apparatus and method for transmitting/receiving pilot signals in an OFDM communication system

(75) Inventors: Hoon Huh, Seongnam-si (KR); Soon-Young Yoon, Seongnam-si (KR); Jae-Hee Cho, Seoul (KR); Sang-Hoon Sung, Suwon-si (KR); Jee-Hyun Kim, Seongnam-si (KR); In-Seok Hwang, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/919,037

(22) Filed: Aug. 16, 2004

(30) Foreign Application Priority Data
Aug. 14, 2003 (KR) P2003-56598

(51) Int. Cl. H04J 11/00

(52) U.S. Cl. 370/210

(57) ABSTRACT

A radio communication system divides an entire frequency band into a plurality of subcarrier bands, forms a symbol from signals on the subcarrier bands, forms a frame from a plurality of symbols, transmits a pilot signal within symbols in a predetermined position of the frame, and transmits a data signal within symbols other than the symbols for transmitting the pilot signal. A transmitter generates the pilot signal, performs an inverse fast Fourier transform (IFFT) on the pilot signal by applying an IFFT size which is less than an IFFT size applied to the data signal, and transmits the IFFT-processed reference signal to a receiver.

This application claims priority under 35 U.S.C. § 119 to an application entitled “Apparatus and Method for Transmitting/Receiving Pilot Signals in an OFDM Communication System” filed in the Korean Intellectual Property Office on Aug. 14, 2003 and assigned Ser. No. 2003-56598, the contents of which are incorporated herein by reference.

### BACKGROUND OF THE INVENTION

1. Field of the Invention

The present invention relates generally to a communication system employing an Orthogonal Frequency Division Multiplexing technique, and in particular, to a pilot signal transmission/reception apparatus and method for minimizing a pilot overhead.

2. Description of the Related Art

The development of communication systems has caused an increase in the amount of service data desired by the system users and an increase in the processing speed of the system. When data is transmitted at a high rate in a radio channel of a mobile communication system, a bit error rate (BER) increases due to the influence of multipath fading and the Doppler effect. Therefore, a radio access technique suitable for the radio channel is required. Currently, a spread spectrum modulation technique having a relatively low transmission power and a low detection probability is popularly used as the radio access technique.

The spread spectrum technique is classified into a Direct Sequence Spread Spectrum (DSSS) technique and a Frequency Hopping Spread Spectrum (FHSS) technique. The DSSS technique is advantageous in that it can actively cope with the multipath fading occurring in a radio channel by using a Rake receiver employing a path diversity technique for a channel. The DSSS technique has a high efficiency at a rate of up to 10 Mbps. However, when data is transmitted at a high rate of 10 Mbps or higher, interference between chips increases causing an abrupt increase in hardware complexity and multiuser interference, thereby restricting the number of users that can be accommodated by a base station (BS), i.e., restricting the entire system capacity.

The FHSS technique is advantageous in that it can reduce the influence of the multipath fading and the narrow band impulse noises because the FHSS technique transmits data by hopping frequencies using a random sequence. It is very important for the FHSS technique to acquire correct synchronization between a transmitter and a receiver. However, during the high-speed data transmission, it is difficult to acquire the correct synchronization between a base station and a receiver.

Recently, the Orthogonal Frequency Division Multiplexing (OFDM) technique is popularly used as a radio access technique suitable for a high-speed data transmission. One of the OFDM based techniques recently used as a technique for high-speed data transmission in a wired/wireless channel is a technique for transmitting data using multiple carriers. The OFDM technique is a kind of Multi-Carrier Modulation (MCM) technique for converting a serial input symbol stream into parallel symbols, and modulating the parallel symbols with multiple orthogonal subcarriers before transmission.

The OFDM technique, being similar to the existing Frequency Division Multiplexing (FDM) technique, obtains optimal transmission efficiency during a high-speed data transmission by maintaining the orthogonality between the subcarriers, and in addition, has a high frequency efficiency and is robust against the multipath fading, thereby obtaining an optimal transmission efficiency during a high-speed data transmission. In addition, the OFDM technique, because it uses overlapped frequency spectrums, has a high frequency efficiency, is robust against the frequency selective fading and the multipath fading, reduces inter-symbol interference (ISI) using a guard interval, enables simple hardware design for an equalizer, and is robust against impulse noises. For such advantages, the OFDM technique is actively used.

The operation of a transmitter and a receiver in a communication system employing the OFDM technique (hereinafter referred to as an “OFDM communication system”) will be described in brief herein below.

In a transmitter, or a base station, of the OFDM communication system, the input data is modulated with a subcarrier signal through a scrambler, an encoder and an interleaver. The transmitter provides a variable data rate, and has a different coding rate, interleaving size and modulation scheme according to the data rate. Commonly, the encoder uses a coding rate of ½ or ¾, and an interleaving size for preventing a burst error is determined according to the Number of Coded Bits per Symbol (NCBPS). The transmitter uses one of a Quadrature Phase Shift Keying (QPSK), a 8-ary Phase Shift Keying (8PSK), a 16-ary Quadrature Amplitude Modulation (16QAM) and a 64-ary Quadrature Amplitude Modulation (64QAM) as the modulation scheme according to the data rate. A predetermined number of pilot subcarriers are added to the signals modulated by the above elements with a predetermined number of subcarriers, and generated into one OFDM symbol through an inverse fast Fourier transform (IFFT) process. A guard interval for removing the inter-symbol interference in a multipath channel environment is inserted into the OFDM symbol, and then is finally input to a radio frequency (RF) processor through a symbol generator. The RF processor RF-processes its input signal and transmits the RF signal over the air.

In a receiver, or a mobile station (MS), of the OFDM communication system, a reverse process for the process performed in the transmitter is performed, and a synchronization process is additionally performed. For a received OFDM symbol, a process of estimating a frequency offset and a symbol offset using a predetermined training sequence must be initially performed. Thereafter, a guard interval-removed data symbol is restored into a predetermined number of subcarriers to which a predetermined number of pilot subcarriers are added, through a fast Fourier transform (FFT) process. In order to overcome a path delay phenomenon in an actual radio channel, an equalizer estimates a channel condition for a received channel signal, and removes the signal distortion introduced in the actual radio channel from the received channel signal. The data channel-estimated through the equalizer is converted into a bit stream, and the bit stream is deinterleaved by a deinterleaver, and then, output as final data through a decoder and a descrambler.

In the OFDM communication system, the transmitter, or a base station, transmits data subcarrier signals or data signals to the receiver, or a mobile station. The base station simultaneously transmits pilot subcarrier signals or pilot signals together with the data signals.

The reason for transmitting the pilot signals is to enable time synchronization acquisition, frequency synchronization acquisition, cell search (or base station identification), channel estimation, and channel quality information (CQI) measurement.

A technique for transmitting the pilot signals is roughly classified into a pilot tone technique and a pilot symbol technique. First, the pilot tone technique will be described with reference to FIG. 1.

FIG. 1 is a diagram illustrating a process of transmitting pilot signals based on the pilot tone technique in a general OFDM communication system. Before a description of FIG. 1 is given, it should be noted that the pilot tone technique is a technique for transmitting a pilot signal and a data signal within the same OFDM symbol through the different subcarriers, and a subcarrier for transmitting the pilot signal is selected based on a frequency domain and a time domain. The subcarrier for transmitting the pilot signal is selected based on a coherence bandwidth in the frequency domain and a coherence time in the time domain. A unit signal transmitted through each of the subcarriers for a basic unit time period, i.e. an OFDM symbol period, of the OFDM communication system is defined as a “symbol”, and the sum of the symbols corresponding to all of the subcarriers of the OFDM communication system is defined as an “OFDM symbol.” Symbols constituting the OFDM symbol are modulation symbols modulated by one of the above-stated modulation scheme such as QPSK, 8PSK, 16QAM and 64QAM, and will be referred to as “symbols” for the convenience of explanation.

The coherence bandwidth represents a maximum bandwidth where it is assumed that a channel is constant in the frequency domain. The coherence time represents a maximum time where it is assumed that a channel is constant in the time domain. Because it can be assumed that a channel is constant within the coherence bandwidth and coherence time, even though a pilot signal is transmitted through only one subcarrier for the coherence bandwidth and the coherence time, it is sufficient for the synchronization acquisition, the channel estimation, and the base station identification. As a result, it is possible to maximize the transmission of the data channel signals, thereby contributing to an overall improvement in the entire system performance. In conclusion, a maximum frequency interval for transmitting the pilot signals corresponds to a coherence bandwidth, and a maximum time interval, or a maximum OFDM symbol time interval, for transmitting the pilot signals corresponds to a coherence time.

Referring to FIG. 1, the vertical axis represents a frequency axis and the horizontal axis represents a time axis. Further, the subcarriers for transmitting the pilot signals (hereinafter referred to as “pilot subcarriers”) are distributed to all of the OFDM symbols, and there exists one pilot subcarrier for every 8 subcarriers. Each of the subcarriers, except the pilot subcarriers, i.e. subcarriers for transmitting data, will be referred to as “data subcarriers.” In order to normally perform a cell search, channel estimation, and a CQI measurement with the pilot subcarriers in a multicell environment, the power level of pilot subcarriers must be boosted as compared with the data subcarriers before being transmitted. The boosting of the pilot subcarriers means increasing the transmission power of a signal transmitted through the pilot subcarriers as compared with the transmission power of a signal transmitted through the data subcarriers.

The time synchronization acquisition, the frequency synchronization acquisition, the cell search, the channel estimation, and the CQI measurement processes based on the pilot tone technique will be described herein below.

(1) Time Synchronization Acquisition Process

Before a description of the time synchronization acquisition process is given, it should be noted that in the OFDM communication system, when an OFDM symbol is transmitted, a guard interval is inserted to remove any interference between a previous OFDM symbol transmitted at a previous OFDM symbol time and a current OFDM symbol transmitted at a current OFDM symbol time. The guard interval is inserted using either a ‘cyclic prefix’ technique for copying a predetermined number of the last samples of an OFDM symbol in a time domain and inserting the copied samples into an available OFDM symbol, or a ‘cyclic postfix’ technique for copying a predetermined number of the first samples of an OFDM symbol in a time domain and inserting the copied samples into an available OFDM symbol.

The examples and embodiments described herein will utilize the cyclic prefix method in that the base station copies a predetermined number of the last samples of an OFDM symbol in which the pilot subcarriers and the data subcarriers are mixed, and then inserts the copied samples in the OFDM symbol. Then the mobile station detects a correlation between a guard interval of a received OFDM symbol and the predetermined number of the last samples of the OFDM symbol, and acquires the time synchronization when the correlation has a peak value. However, because the time synchronization is acquired using the guard interval inserted in the form of the cyclic prefix, when the guard interval signal experiences multipath fading, the guard interval signal is distorted due to a multipath signal, making it difficult to acquire the time synchronization.

(2) Frequency Synchronization Acquisition Process

As described in the time synchronization acquisition process, the base station copies a predetermined number of the last samples of an OFDM symbol in which the pilot subcarriers and the data subcarriers are mixed, and then inserts the copied samples in the form of the ‘cyclic prefix’ to generate a guard interval before transmission. Then the mobile station detects a correlation between the guard interval of a received OFDM symbol and the predetermined number of the last samples of the OFDM symbol, and acquires the frequency synchronization from a phase difference therebetween. However, because the frequency synchronization is acquired using the guard interval generated based on the cyclic prefix technique, when the guard interval signal experiences multipath fading, the guard interval signal is distorted due to the multipath signal fading effects processed during the time synchronization acquisition process, making it difficult to acquire the frequency synchronization.

(3) Cell Search Process

The base station transmits the pilot symbols at a power level high enough so that the pilot symbols can reach a cell boundary, a relatively high transmission power as compared with the transmission power of the data symbols, while maintaining a particular pattern, i.e. pilot pattern. The reason base station transmits the pilot symbols such that the pilot symbols can reach a cell boundary with relatively high transmission power, while maintaining a particular pattern, i.e. the reason for boosting the pilot symbols, is as follows. When a mobile station enters a new cell, the mobile station has no information regarding a base station where the mobile station is currently located. In order for the mobile station to detect the base station where the mobile station is located, the mobile station must use the pilot symbols. Therefore, the base station transmits the pilot symbols at a relatively high transmission power level to maintain a particular pattern so that the mobile station can detect the base station where the mobile station is located.

The “pilot pattern” is a generated pattern of the pilot symbols transmitted by the base station. That is, the pilot pattern is generated by using the slope of the pilot symbols and a start point where the transmission of a graph of the pilot symbols is initiated. Therefore, the OFDM communication system must be designed such that the base stations continued in the OFDM communication system should have different pilot patterns so as to make it possible to identify the different base stations. The pilot pattern is generated by taking into consideration a coherence bandwidth and a coherence time.

For the base station identification, the pilot symbols are boosted before being transmitted. However, the boosted pilot symbols may act as interference components for other data symbols. In order to distinguish the pilot patterns, it is necessary to continuously monitor the pilot symbols distributed to several OFDM symbols. Therefore, a mobile station's load for monitor the pilot symbols increases, and the load increase causes an increase in power consumption.

(4) Channel Estimation and CQI Measurement Processes

As described above, the pilot symbols are boosted as compared with the data symbols, and the boosted pilot symbols function as interference components for the data symbols. Therefore, the channel estimation and the CQI measurement for which the pilot symbols are used in a multicell environment are inferior in their precision. For example, the channel estimation and the CQI measurement are performed based on a carrier-to-interference and noise ratio (CINR), and when the boosted pilot symbols of another cell function as interference to the pilot symbols and the data symbols of a corresponding cell, the accuracy of the channel estimation and the CQI measurement decrease.

The pilot tone technique has been described with reference to FIG. 1. Next, the pilot symbol technique will be described with reference to FIG. 2.

Before a description of FIG. 2 is given, it should be noted that the pilot symbol technique is a technique for defining an OFDM symbol for transmitting pilot symbols and an OFDM symbol for transmitting data symbols, and transmitting pilot symbols only at the defined OFDM symbol. Herein, the OFDM symbol for transmitting pilot symbols will be referred to as a “pilot OFDM symbol,” and the OFDM symbol for transmitting data symbols will be referred to as a “data OFDM symbol.” The pilot symbol technique defines a period of the pilot OFDM symbol, and the pilot OFDM symbol period is previously agreed to between a base station and a mobile station.

FIG. 2 is a diagram illustrating a process of transmitting pilot signals based on a pilot symbol technique in a general OFDM communication system.

Referring to FIG. 2, the vertical axis represents a frequency axis and the horizontal axis represents a time axis. Further, the pilot symbols are distributed only to the pilot OFDM symbols. The OFDM symbols, except for the pilot OFDM symbols, are the data OFDM symbols. In order to normally perform the time synchronization acquisition, the frequency synchronization acquisition, the cell search, the channel estimation, and the CQI measurement with the pilot symbols in a multicell environment, each base station must transmit a predetermined sequence, for example, a pseudo-random noise (PN) sequence, together with the pilot OFDM symbol.

The time synchronization acquisition, the frequency synchronization acquisition, the cell search, the channel estimation, and the CQI measurement processes based on the pilot symbol technique will be described herein below.

(1) Time Synchronization Acquisition Process

The base station transmits the pilot symbols such that a corresponding base station should have a predetermined PN sequence for the pilot OFDM symbol period. The pilot OFDM symbol period periodically has the same PN sequence, and is periodically repeated. Then the mobile station auto-correlates the pilot symbols received in a previous pilot OFDM symbol period with the pilot symbols received in a current pilot OFDM symbol period, and acquires the time synchronization when the correlation value has a peak value.

(2) Frequency Synchronization Acquisition Process

As described in the time synchronization acquisition process, the base station transmits the pilot symbols such that a corresponding base station should have a predetermined PN sequence for the pilot OFDM symbol period. Then the mobile station estimates a frequency offset from a phase difference between the pilot symbols received in a previous pilot OFDM symbol period and the pilot symbols received in a current pilot OFDM symbol period.

(3) Cell Search Process

The base station transmits the pilot symbols using its own PN sequence so that a mobile station can identify the base station. The base stations contained in the OFDM communication system are separately assigned unique PN sequences which are applied to the pilot signals, and a mobile station correlates the PN sequences representing the base stations, to the received pilot symbols on a one-to-one basis, and when a peak is detected, the mobile station identifies the base station corresponding to the PN sequence as the base station where the mobile station is located. In the pilot symbol technique, because the pilot symbols are transmitted using the PN sequence, it is not necessary to separately boost the pilot symbols as compared with the data symbols. In addition, because the pilot symbols are transmitted only in periodically arranged pilot OFDM symbol periods, the mobile station only has to receive the pilot symbols in the pilot OFDM symbol period. Therefore, the mobile station, unlike in the pilot tone technique, has no load for monitoring the pilot symbols, thereby minimizing the power consumption.

(4) Channel Estimation and COI Measurement Processes

As described above, because the pilot symbol technique is not required to separately boost the pilot symbols as compared with the data symbols, the pilot symbols do not act as interference components for the data symbols. Therefore, even in the multicell environment, the channel estimation and the CQI management based on the pilot symbol technique have reliable accuracy.

However, because the pilot symbol technique transmits the pilot symbols for the entire pilot OFDM symbol period, it is possible to adjust a pilot symbol ratio with only pilot symbol insertion and pilot symbol deletion. Therefore, compared with the pilot tone technique, providing an OFDM symbol in which the pilot subcarriers and the data subcarriers are mixed, the pilot symbol technique is inferior in pilot assignment flexibility. For example, when a mobile communication channel varies at a high speed in the time domain but varies at a relatively low speed in the frequency domain, in order to trace a time-varying characteristic of the mobile communication channel, in case of the pilot tone technique it is efficient to reduce the pilot symbol insertion frequency in the frequency domain. However, the pilot symbol technique can insert and delete pilot symbols on the basis of only the time domain, if the pilot symbol insertion frequency is increased in the time domain, the overhead ratio abruptly increases.

A comparison between problems of the pilot tone technique and the pilot symbol technique will be made herein below.

First, because the pilot tone technique acquires the time synchronization and the frequency synchronization by comparing and correlating the guard interval inserted in the cyclic prefix technique with the corresponding repeated symbols of the OFDM symbol, the pilot tone technique is inferior in reliability in a channel environment having considerable multipath fading. However, because the pilot symbol technique acquires the time synchronization and the frequency synchronization by performing an auto-correlation between the periodically arranged pilot OFDM symbol periods, the pilot symbol technique can acquire the time synchronization and the frequency synchronization even in a channel environment having considerable multipath fading.

Second, because the pilot tone technique must check a pilot pattern to identify a base station, a mobile station must continuously monitor the pilot symbols for all of the OFDM symbols to check the pilot pattern, thereby increasing the power consumption. However, because the pilot symbol technique transmits a PN sequence previously determined for a base station identification for a pilot OFDM symbol period, it is not necessary to monitor the pilot symbols, thereby minimizing the power consumption.

Third, because the pilot tone technique boosts the pilot symbols as compared with the data symbols before transmission, the boosted pilot symbols function as interference components for other pilot symbols and data symbols, thereby reducing the reliability of the channel estimation and the CQI measurement. However, because the pilot symbol technique does not boost the pilot symbols, the pilot symbols do not function as interference components for other pilot symbols and data symbols, thereby securing a high reliability of the channel estimation and the CQI measurement.

Fourth, because the pilot tone technique transmits the pilot symbols through only the corresponding pilot subcarriers by taking into consideration the coherence time and the coherence bandwidth, the overhead for the pilot signals from among the total signals is relatively low. However, because the pilot symbol technique transmits the pilot symbols through all of the symbols in a pilot OFDM symbol period, the overhead for the pilot symbols from among all of the signals is relatively high.

Fifth, because the pilot tone technique transmits the pilot symbols through only the corresponding pilot subcarriers by taking into consideration the coherence time and the coherence bandwidth, the pilot tone technique is superior in pilot assignment flexibility. However, because the pilot symbol technique transmits the pilot symbols through only a predetermined pilot OFDM symbol in the time domain, the pilot symbol technique is inferior in the pilot assignment flexibility.

### SUMMARY OF THE INVENTION

It is, therefore, an object of the present invention to provide an apparatus and method for generating the pilot signals in an OFDM mobile communication system.

It is another object of the present invention to provide an apparatus and method for transmitting the pilot signals in an OFDM mobile communication system.

It is further anther object of the present invention to provide a pilot signal transmission apparatus and method for minimizing the overhead of the pilot signals in an OFDM mobile communication system.

It is yet another object of the present invention to provide an apparatus and method for receiving the pilot signals in an OFDM mobile communication system.

In accordance with one aspect of the present invention, there is provided a method for transmitting a reference signal in a transmitter of a radio communication system which divides an entire frequency band into a plurality of subcarrier bands, forms a symbol with signals on the subcarrier bands, forms a frame with a plurality of symbols, transmits the reference signal within symbols in a predetermined position of the frame, and transmits a data signal within symbols other than the symbols for transmitting the reference signal. The method includes the steps of performing an inverse fast Fourier transform (IFFT) on a reference signal by applying an IFFT size which is less than an IFFT size applied to the data signal; and transmitting to a receiver the IFFT-processed reference signal.

In accordance with another aspect of the present invention, there is provided a method for generating a frame in an Orthogonal Frequency Division Multiplexing (OFDM) communication system including a first inverse fast Fourier transform (IFFT) section for generating a reference symbol in a time domain from a reference signal in a frequency domain, and a second IFFT section for generating a data symbol in the time domain from a data signal in the frequency domain. In the method, one reference symbol in the time domain is provided for a predetermined number of data symbols generated from the second IFFT block, and a time size of the reference symbol is defined as a ratio of the number of input points of the first IFFT section to the number of input points of the second IFFT section when a time size of each data symbol is set to ‘1’.

In accordance with further another aspect of the present invention, there is provided a method for receiving a reference signal in a receiver of a radio communication system which divides an entire frequency band into a plurality of subcarrier bands, forms a symbol from signals on the subcarrier bands, forms a frame from a plurality of symbols, transmits the reference signal within symbols in a predetermined position of the frame, and transmits a data signal within symbols other than the symbols for transmitting the reference signal. The method includes the steps of receiving a signal and detecting a reference signal from the received signal; and performing a fast Fourier transform (FFT) on the reference signal by applying an FFT size which is less than an FFT size applied to the data signal.

In accordance with yet another aspect of the present invention, there is provided an apparatus for transmitting a reference signal in a transmitter of a radio communication system which divides an entire frequency band into a plurality of subcarrier bands, forms a symbol from signals on the subcarrier bands, forms a frame from a plurality of symbols, transmits the reference signal within symbols in a predetermined position of the frame, and transmits a data signal within symbols other than the symbols for transmitting the reference signal. The apparatus includes an inverse fast Fourier transform (IFFT) section for receiving a reference signal and performing an IFFT on the reference signal by applying an IFFT size which is less than an IFFT size applied to a data signal; and a transmitter for transmitting to a receiver the IFFT-processed reference signal.

In accordance with still another aspect of the present invention, there is provided an apparatus for receiving a reference signal in a receiver of a radio communication system which divides an entire frequency band into a plurality of subcarrier bands, forms a symbol from signals on the subcarrier bands, forms a frame from a plurality of symbols, transmits the reference signal within symbols in a predetermined position of the frame, and transmits a data signal within symbols other than the symbols for transmitting the reference signal. The apparatus includes a receiver for receiving a signal and detecting a reference signal from the received signal; and a fast Fourier transform (FFT) section for performing a FFT on the reference signal by applying an FFT size which is less than an FFT size applied to the data signal.

In accordance with still another aspect of the present invention, there is provided a method for transmitting a signal in a transmitter of a radio communication system which divides an entire frequency band into a plurality of subcarrier bands, forms a symbol from signals on the subcarrier bands, forms a frame from a plurality of symbols, transmits a reference signal within symbols in a predetermined position of the frame, and transmits a data signal within symbols other than the symbols for transmitting the reference signal. The method comprises the steps of inserting ‘0’s in predetermined positions of a reference signal, multiplexing a data signal and the ‘0’-inserted reference signal, performing an Inverse Fast Fourier transform (IFFT) on the multiplexed data signal and the ‘0’-inserted reference signal, performing a truncation of the IFFT-performed signal if the IFFT-performed signal is the reference signal, and transmitting the truncation-performed signal.

In accordance with still another aspect of the present invention, there is provided a method for receiving a signal in a receiver of a radio communication system which divides an entire frequency band into a plurality of subcarrier bands, forms a symbol from signals on the subcarrier bands, forms a frame from a plurality of symbols, transmits a reference signal within symbols in a predetermined position of the frame, and transmits a data signal within symbols other than the symbols for transmitting the reference signal. The method comprises the steps of performing a repetition of a received signal if the received signal is a reference signal, and performing a Fast Fourier transform (FFT) on the repetition-performed signal.

### BRIEF DESCRIPTION OF THE DRAWINGS

The above and other objects, features and advantages of the present invention will become more apparent from the following detailed description when taken in conjunction with the accompanying drawings in which:

FIG. 1 is a diagram illustrating a process of transmitting pilot signals based on a pilot tone technique in a general OFDM communication system;

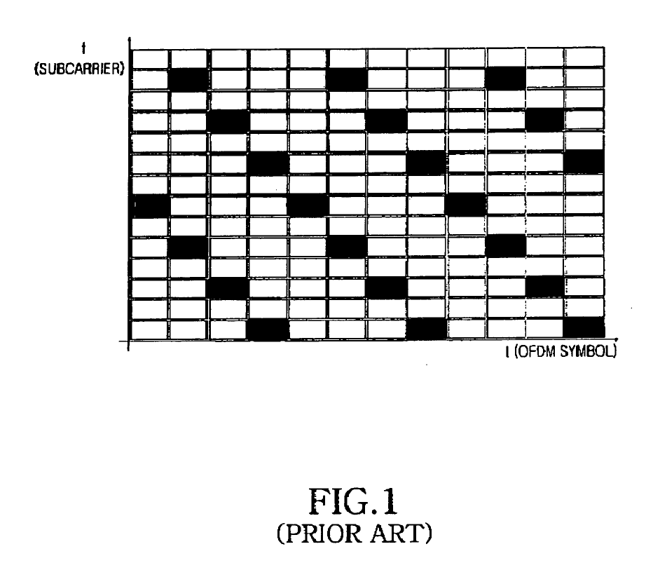

FIG. 2 is a diagram illustrating a process of transmitting pilot signals based on a pilot symbol technique in a general OFDM communication system;

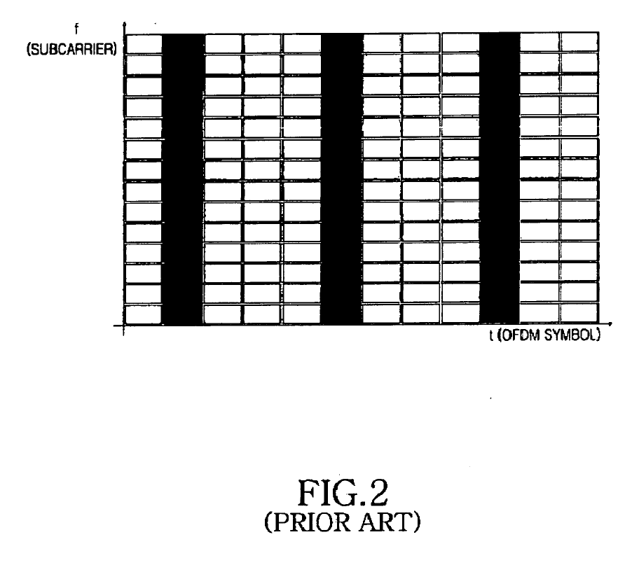

FIG. 3 is a diagram illustrating a process of transmitting pilot signals based on a pilot symbol technique in an OFDM communication system according to an embodiment of the present invention;

FIG. 4 is a diagram illustrating a process of transmitting pilot signals based on a new pilot symbol technique and a general pilot symbol technique in an OFDM communication system according to an embodiment of the present invention;

FIG. 5 is a diagram illustrating a frame format of an OFDM communication system according to an embodiment of the present invention;

FIG. 6 is a flowchart illustrating a signal transmission procedure performed by an OFDM transmission apparatus in an OFDM communication system according to an embodiment of the present invention;

FIG. 7 is a flowchart illustrating a signal reception procedure performed by an OFDM reception apparatus in an OFDM communication system according to an embodiment of the present invention;

FIG. 8 is a block diagram illustrating an internal structure of a first OFDM transmission apparatus according to an embodiment of the present invention;

FIG. 9 is a block diagram illustrating an internal structure of a first OFDM reception apparatus according to an embodiment of the present invention;

FIG. 10 is a block diagram illustrating an internal structure of a second OFDM transmission apparatus according to an embodiment of the present invention; and

FIG. 11 is a block diagram illustrating an internal structure of a second OFDM reception apparatus according to an embodiment of the present invention.

### DETAILED DESCRIPTION OF THE PREFERRED EMBODIMENT

A preferred embodiment of the present invention will now be described in detail with reference to the annexed drawings. In the following description, a detailed description of known functions and configurations incorporated herein has been omitted for conciseness.

The present invention proposes a method and apparatus for generating and transmitting/receiving pilot signals in a communication system employing Orthogonal Frequency Division Multiplexing (OFDM) technology (hereinafter referred to as an “OFDM communication system”). In particular, the present invention proposes a pilot signal transmission/reception method and apparatus for minimizing the overhead associated with pilot signals while using a pilot symbol technique in an OFDM communication system. That is, in the present invention, an OFDM communication system generates a frame with pilot signals and data signals based on the pilot symbol technique, and in order to minimize the pilot signal overhead caused by the pilot symbol technique, decreases an IFFT size applied to an OFDM symbol period during which the pilot signals are transmitted, compared with an IFFT size applied to an OFDM symbol period during which the data signals are transmitted, thereby minimizing the overhead of the pilot signals. An FFT size applied for the reception of the pilot signals, corresponding to the IFFT size applied to the transmission of the pilot signals, is also reduced. The term “IFFT size” refers to the number of input points of the IFFT block, and the term “FFT size” refers to the number of input points of the FFT block.

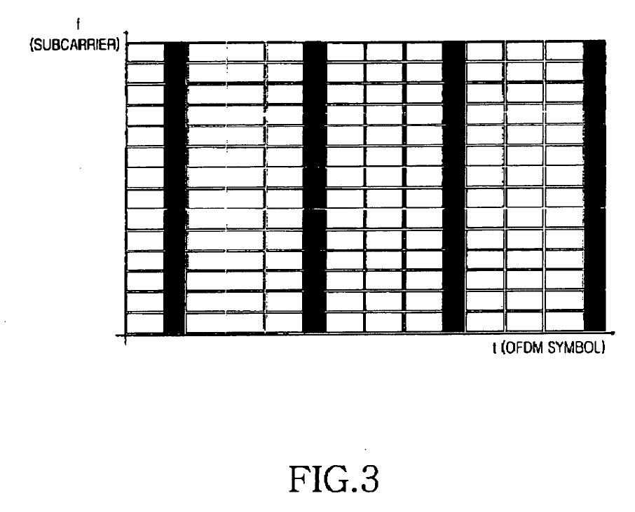

FIG. 3 is a diagram illustrating a process of transmitting pilot signals based on a pilot symbol technique in an OFDM communication system according to an embodiment of the present invention. Before a description of FIG. 3 is given, it is noted that a pilot symbol technique is a technique for predefining an OFDM symbol for transmitting the pilot signals and an OFDM symbol for transmitting data signals, and transmitting pilot signals only at the predefined OFDM symbol. Herein, a unit signal transmitted through each of the subcarriers for a basic unit time period, i.e. an OFDM symbol period, of the OFDM communication system is defined as a “symbol”, and the sum of subcarriers carrying all of the modulation symbols of the OFDM communication system is defined as an “OFDM symbol.” Further, the OFDM symbol for transmitting the pilot signals will be referred to as a “pilot OFDM symbol,” and the OFDM symbol for transmitting the data signals will be referred to as a “data OFDM symbol.” The pilot symbol technique defines a period of the pilot OFDM symbol, and the pilot OFDM symbol period is predefined between a transmitter, or a base station (BS), and a receiver, or a mobile station (MS).

Referring to FIG. 3, the vertical axis represents a frequency axis and the horizontal axis represents a time axis. Further, the subcarriers for transmitting the pilot signals are distributed only to the pilot OFDM symbols. Herein, the subcarriers for transmitting the pilot signals will be referred to as “pilot subcarriers,” and the subcarriers for transmitting the data signals will be referred to as “data subcarriers.” As illustrated in FIG. 3, the present invention differentiates an IFFT/FFT size applied to a data OFDM symbol period, or a data OFDM symbol, from an IFFT/FFT size applied to a pilot ODM symbol period, or a pilot OFDM symbol.

As described above, because the pilot symbol technique transmits pilot symbols within all of the symbols in a pilot OFDM symbol period, the overhead of the pilot signals for all of the whole signals is undesirably increased. The present invention reduces an IFFT/FFT size applied to a pilot OFDM symbol period as compared with an IFFT/FFT size applied to a data OFDM symbol period, in order to minimize the overhead of the pilot signals transmitted in the pilot OFDM symbol period. If the IFFT/FFT size applied to the data OFDM symbol period is defined as ‘N’, the IFFT/FFT size applied to the pilot OFDM symbol period becomes ‘N/n’. The ‘n’ is a multiple proportion of the IFFT/FFT size applied to the pilot OFDM symbol to the IFFT/FFT size applied to the data OFDM symbol. For example, for n=4, if the IFFT/FFT size applied to the data OFDM symbol period is 2048 input points, the IFFT/FFT size applied to the pilot OFDM symbol period becomes 2048/4=512 input points.

In this way, if an IFFT/FFT size applied to the pilot OFDM symbol period is set to 1/n of an IFFT/FFT size applied to the data OFDM symbol period, the time domain size of the pilot OFDM symbol period is reduced to 1/n of the time domain size of the data OFDM symbol period. Because the time domain size of the pilot OFDM symbol period is reduced to 1/n, the overhead of the pilot signals is also reduced to 1/n. In addition, due to a characteristic of the FFT, the value ‘n’ is limited to an exponential value of 2.

An IFFT/FFT size applied to the pilot OFDM symbol period is determined according to the characteristics of the OFDM communication system. As the value ‘n’ increases, a time domain size of the pilot OFDM symbol period becomes less than the time domain size of the data OFDM symbol period, causing a further reduction in the overhead of the pilot signals. FIG. 3 shows a process of transmitting the pilot signals in the case where an IFFT/FFT size applied to the data OFDM symbol period is set to N and an IFFT/FFT size applied to the pilot OFDM symbol period is set to N/2. As illustrated in FIG. 3, the time domain length (or size) of the pilot OFDM symbol period is reduced to ½ of the time domain length of the data OFDM symbol period. In addition, because the IFFT/FFT size applied to the pilot OFDM symbol period is reduced to ½ of the IFFT/FFT size applied to the data OFDM symbol size, the length in the frequency domain of the symbols in the pilot OFDM symbol period is doubled. Since the increase in the length in the frequency domain is the IFFT/FFT characteristic, a detailed description thereof will be omitted.

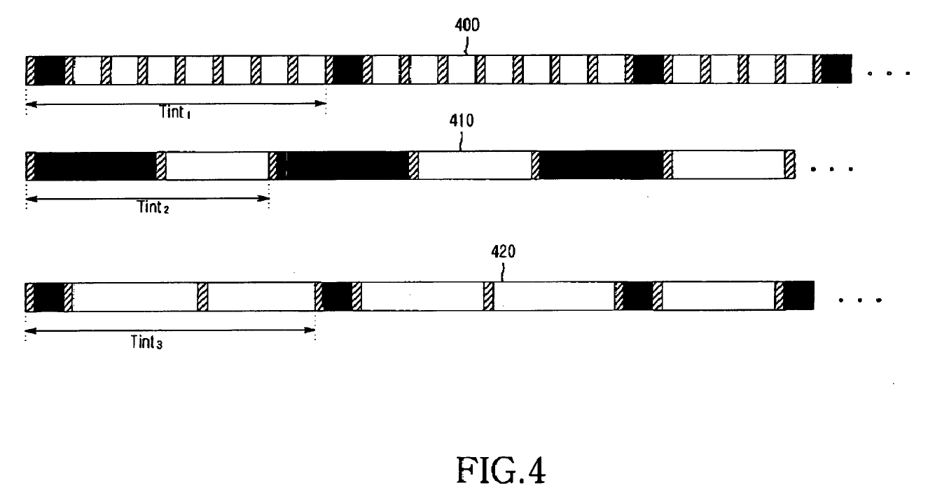

FIG. 4 is a diagram illustrating a process of transmitting pilot signals based on a new pilot symbol technique and a general pilot symbol technique in an OFDM communication system according to an embodiment of the present invention.

Referring to FIG. 4, reference numeral 400 represents a signal transmitted in the time domain based on a general pilot symbol technique where the FFT sizes applied to the pilot symbols and the data symbols are both small, reference numeral 410 represents a signal transmitted in the time domain based on a general pilot symbol technique where the FFT sizes applied to the pilot symbols and the data symbols are both large, and reference numeral 420 represents a signal transmitted in the time domain based on a pilot symbol technique according to an embodiment of the present invention. In FIG. 4, the pilot symbols are shown in black and the data symbols are shown in white.

First, a description will be made of the signal 400 transmitted in a time domain based on a general pilot symbol technique where the FFT sizes applied to the pilot symbols and the data symbols are both small.

Describing the signal 400 transmitted, pilot symbols are transmitted while taking into consideration the coherence time and the coherence bandwidth. As described above, the pilot symbols are transmitted through all of the symbols in a pilot OFDM symbol period, and the data symbols are transmitted through all of the symbols in a symbol period, except for the pilot OFDM symbol period.

The signal 400 has a pilot symbol period Tᵢₙₜ₁ during which one pilot symbol is transmitted for every 7 data symbols. In addition, the signal 400 includes therein a guard interval, shown as the hatched elements, inserted by the cyclic prefix technique to remove interference due to the multipath fading. The length of the guard interval can be set longer than a maximum delay time possibly occurring in a channel according to a characteristic of the channel, and once the length of the guard interval is determined, the corresponding OFDM communication system has the determined fixed length.

In FIG. 4, the guard interval length is set to, for example, 128 samples. Therefore, in the signal 400, the overhead caused by the guard interval is 20%, and the overhead caused by the pilot symbols is 12.5%. If the FFT size increases, the overhead by the guard interval can be reduced, but the overhead by the pilot symbols increases due to the increase in the FFT size.

Second, a description will be made of the signal 410 transmitted in the time domain based on a general pilot symbol technique where FFT sizes applied to pilot symbols and data symbols are both large.

Describing the signal 410, the pilot symbols are transmitted through all of the symbols in a pilot OFDM symbol period, and the data symbols are transmitted through all of the symbols in a symbol period, except for during the pilot OFDM symbol period. It is assumed herein that the FFT size applied to the OFDM symbol period is 2048 input points. As the FFT size applied to the OFDM symbol period increases from 512 input points to 2048 input points, the overhead of the guard interval is reduced. Therefore, the signal 410 has a pilot symbol period Tᵢₙₜ₂ which is shorter than the pilot symbol period Tᵢₙ₁ of the signal 400. However, as illustrated in FIG. 4, the overhead by the guard interval is reduced from 20% to 5.9%, but the overhead by the pilot symbols is increased from 12.5% to 50%.

Finally, describing the signal 420 transmitted in a time domain based on a pilot symbol technique according to an embodiment of the present invention, as described above, pilot symbols are transmitted through all of the symbols in a pilot OFDM symbol period, but the FFT size applied to the pilot OFDM symbol period is set less than the FFT size applied to the data OFDM symbol period, thereby minimizing the length of the pilot OFDM symbol period. Of course, the data symbols are transmitted through all of the symbols in a symbol period except for during the pilot OFDM symbol period. It is assumed herein that the FFT size applied to the data OFDM symbol period is 2048 input points, and the FFT size applied to the pilot OFDM symbol is ¼ of the FFT size applied to the data OFDM symbol period, i.e. 512 input points. If, as described above, the symbols are arranged such that the FFT size applied to the pilot OFDM symbol period is reduced from 2048 input points to 512 input points and a pilot OFDM symbol period Tᵢₙₜ₃ is less than the channel coherence time, then the signal 420 transmitted in the time domain based on the pilot symbol technique according to an embodiment of the present invention has a pilot symbol period Tᵢₙₜ₃ which is less than the pilot symbol period Tᵢₙₜ₂ of the signal 410. In this case, the overhead of the guard interval is 7.7%, and the overhead of the pilot symbols is 12.8%. As a result, the signal 420 transmitted in the time domain based on the pilot symbol technique according to an embodiment of the present invention can minimize both the guard interval overhead and the pilot symbol overhead.

In conclusion, the relation between the pilot symbols and the guard interval according to the FFT size can be summarized herein below.

An OFDM communication system that inserts a pilot OFDM symbol at predetermined periods can reduce the overhead caused by the guard interval by increasing the FFT size applied to the OFDM symbol. However, because the increase in the FFT size applied to the OFDM symbol increases the size of the pilot symbols, the overhead caused by the pilot symbols is also increased. Therefore, the present invention maintains the FFT size applied to data OFDM symbols at a maximum size available in the OFDM communication system, but reduces the FFT size applied to pilot OFDM symbols to 1/n of the FFT size applied to the data OFDM symbols, thereby minimizing the overhead caused by the guard interval and the overhead caused by the pilot symbols. As the FFT size increases, the interference between the subcarriers also increases, thus increasing the possibility that the orthogonality between the subcarriers will be damaged. Therefore, the maximum size value is limited according to the characteristics of the OFDM communication system.

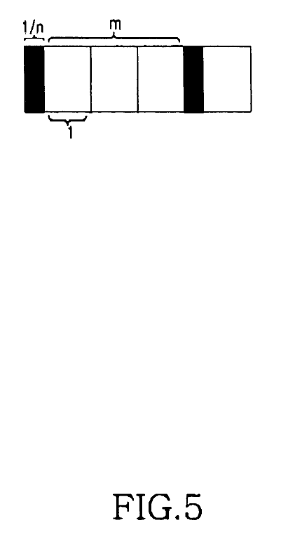

FIG. 5 is a diagram illustrating a frame format of an OFDM communication system according to an embodiment of the present invention. Referring to FIG. 5, it will be assumed that the size of the data OFDM symbol is ‘N’, the ratio of the data OFDM symbol size to the pilot OFDM symbol size is ‘N/n’, and the number of the data OFDM symbols assigned between one pilot OFDM symbol and another pilot OFDM symbol is ‘m’. As illustrated in FIG. 5, one frame is comprised of a plurality of data OFDM symbols and a plurality of pilot OFDM symbols, and the size of the pilot OFDM symbols is set less than the size of the data OFDM symbols to thereby minimize the pilot overhead.

The overhead by the pilot symbols based on the parameters ‘n’ and ‘m’ is illustrated in Table 1.

TABLE 1

| (1/n, m) | Pilot Overhead (%) |
|---|---|
| (1/1, 1) | 50 |
| (1/1, 2) | 33.3 |
| (1/1, 3) | 25 |
| (1/1, 4) | 20 |
| (1/2, 1) | 33.3 |
| (1/2, 2) | 20 |
| (1/2, 3) | 14.3 |
| (1/2, 4) | 11.1 |
| (1/4, 1) | 20 |
| (1/4, 2) | 11.1 |
| (1/4, 3) | 7.7 |
| (1/4, 4) | 5.9 |

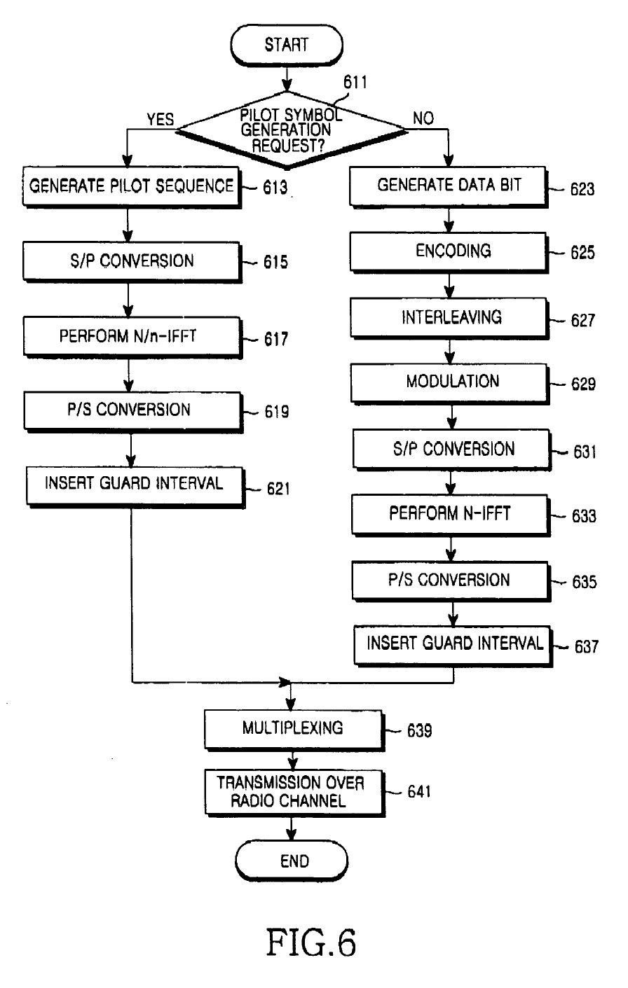

FIG. 6 is a flowchart illustrating a signal transmission procedure by an OFDM transmission apparatus in an OFDM communication system according to an embodiment of the present invention. Before a description of FIG. 6 is given, it is noted that although the OFDM transmission apparatus in the OFDM communication system can be a base station or a mobile station, the OFDM transmission apparatus serves herein as a base station for the convenience of explanation.

Referring to FIG. 6, in step 611, the base station determines if there is a pilot symbol generation request. If it is determined that there is a pilot symbol generation request, the base station proceeds to step 613. In step 613, the base station generates a pilot sequence, or a PN sequence, previously assigned thereto, and then proceeds to step 615. In step 615, the base station performs a serial-to-parallel conversion on the generated serial pilot sequence, and then proceeds to step 617. In step 617, the base station performs an N/n-IFFT on the parallel-converted signals, and then proceeds to step 619. Here, “N/n-IFFT” refers to the IFFT, the size of which or the number of input points of which is N/n. In step 619, the base station performs a parallel-to-serial conversion on the N/n-IFFT-processed parallel signals, and then proceeds to step 621. In step 621, the base station copies a predetermined number of the last symbols of the serial-converted signal, inserts the copied symbols as a guard interval in the cyclic prefix technique, and then proceeds to step 639.

However, if it is determined in step 611 that there is no pilot symbol generation request, the base station proceeds to step 623. In step 623, the base station generates data bits, and then proceeds to step 625. In step 625, the base station encodes the generated data bits, and then proceeds to step 627. In step 627, the base station interleaves the encoded data bits in a predetermined interleaving technique to prevent a burst error, and then proceeds to step 629. In step 629, the base station modulates the interleaved data bits in a predetermined modulation technique, and then proceeds to step 631. Here, the modulation technique includes a Quadrature Phase Shift Keying (QPSK), a 8-ary Phase Shift Keying (8PSK), a 16-ary Quadrature Amplitude Modulation (16QAM) and a 64-ary Quadrature Amplitude Modulation (64QAM) techniques.

In step 631, the base station performs a serial-to-parallel conversion on the serial modulation symbol, or the serial data symbol, modulated according to the modulation technique, and then proceeds to step 633. In step 633, the base station performs an N-IFFT on the parallel-converted signals, and then proceeds to step 635. Here, “N-IFFT” refers to the IFFT, the size of which or the number of input points of which is N. In step 635, the base station performs a parallel-to-serial conversion on the IFFT-processed parallel signals, and then proceeds to step 637. In step 637, the base station copies a predetermined number of the last symbols of the serial-converted signal, inserts the copied symbols as a guard interval, and then proceeds to step 639.

In step 639, the base station multiplexes the pilot symbols and the data symbols, and then proceeds to step 641. In step 641, the base station transmits the multiplexed pilot symbols and data symbols over the air through a radio channel, and then ends the procedure.

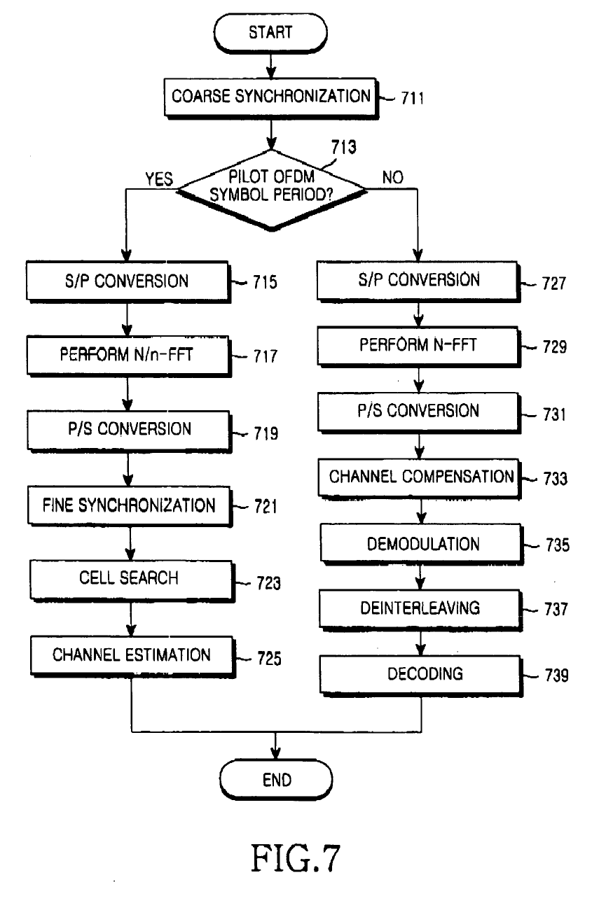

FIG. 7 is a flowchart illustrating a signal reception procedure by an OFDM reception apparatus in an OFDM communication system according to an embodiment of the present invention. Before a description of FIG. 7 is given, it should be noted that although the OFDM reception apparatus in the OFDM communication system can be a mobile station or a base station, the OFDM reception apparatus serves herein as a mobile station for the convenience of explanation.

Referring to FIG. 7, in step 711, the mobile station acquires the coarse synchronization, and then proceeds to step 713. Here, “acquiring coarse synchronization” is a process of acquiring an initial synchronization for time, i.e. OFDM symbol and frame, and frequency. As described above, because the pilot symbol technique is used in the present invention, when an auto-correlation between the pilot symbols for a pilot OFDM symbol received in a previous period and the pilot symbols for a pilot OFDM symbol received in a current period has a peak value, the mobile station determines that the time synchronization is acquired, and then detects the phase difference between the pilot OFDM symbols to estimate the frequency offset. After acquiring the coarse synchronization in this manner, the mobile station determines in step 713 if a current OFDM symbol period is a pilot OFDM symbol period. If it is determined that the current OFDM symbol period is a pilot OFDM symbol period, the mobile station proceeds to step 715.

In step 715, the mobile station performs a serial-to-parallel conversion on the received serial pilot OFDM symbol, and then proceeds to step 717. In step 717, the mobile station performs an N/n-FFT on the parallel-converted signals, and then proceeds to step 719. Here, “N/n-FFT” refers to an FFT, the size of which or the number of input points of which is N/n. In step 719, the mobile station performs a parallel-to-serial conversion on the N/n-FFT-processed parallel signals, and then proceeds to step 721. In step 721, the mobile station acquires a fine synchronization, and then proceeds to step 723. Here, “fine synchronization” is a process of maintaining a change from the initial synchronization for time and frequency.

In step 723, the mobile station performs a cell search for cell identification or handover, and then proceeds to step 725. Here, the “cell search” is a process of mapping a PN sequence for each of base stations contained in the OFDM communication system, previously provided therein for the base station identification, with a PN sequence of the received pilot OFDM symbol on a one-to-one basis, for correlation, and then determining the base station corresponding to the PN sequence having a peak correlation value as the base station where the mobile station is located. In step 725, the mobile station performs a channel estimation using the pilot OFDM symbol, and then ends the procedure.

However, if it is determined in step 713 that the current OFDM symbol period is not a pilot OFDM symbol period, i.e. the current OFDM symbol period is a data OFDM symbol period, then the mobile station proceeds to step 727. In step 727, the mobile station performs a serial-to-parallel conversion on the received data OFDM symbol, and then proceeds to step 729. In step 729, the mobile station performs an N-FFT on the parallel-converted signals, and then proceeds to step 731. Here, “N-FFT” refers to a FFT, the size of which or the number of input points of which is N. In step 731, the mobile station performs a parallel-to-serial conversion on the N-FFT-processed parallel signals, and then proceeds to step 733. In step 733, the mobile station performs the channel compensation, and then proceeds to step 735. In step 735, the mobile station demodulates the channel-compensated data signal in a demodulation technique corresponding to the modulation technique used in the base station, and then proceeds to step 737. In step 737, the mobile station deinterleaves the demodulated data signal in a deinterleaving technique corresponding to the interleaving technique used in the base station, and then proceeds to step 739. In step 739, the mobile station decodes the deinterleaved signal in a decoding technique corresponding to the encoding technique used in the base station, and then ends the procedure.

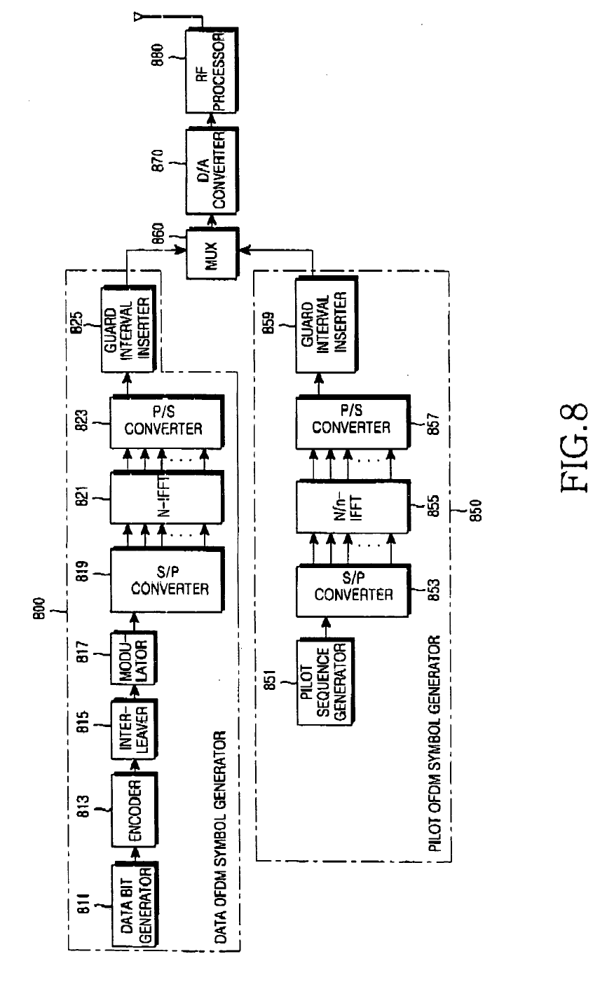

FIG. 8 is a block diagram illustrating an internal structure of a first OFDM transmission apparatus according to an embodiment of the present invention. Referring to FIG. 8, the OFDM transmission apparatus is comprised of a data OFDM symbol generator 800, a pilot OFDM symbol generator 850, a multiplexer (MUX) 860, a digital-to-analog (D/A) converter 870, and a radio frequency (RF) processor 880. The data OFDM symbol generator 800 is comprised of a data bit generator 811, an encoder 813, an interleaver 815, a modulator 817, a serial-to-parallel (S/P) converter 819, an N-IFFT block 821, a parallel-to-serial (P/S) converter 823, and a guard interval inserter 825. The pilot OFDM symbol generator 850 is comprised of a pilot sequence generator 851, a serial-to-parallel (S/P) converter 853, an N/n-IFFT block 855, a parallel-to-serial (P/S) converter 857, and a guard interval inserter 859.

First, the data OFDM symbol generator 800 will be described. The data bit generator 811 generates user data bits and control data bits to be transmitted, and outputs the generated user data bits and control data bits to the encoder 813. For the convenience of explanation, both the user data bits and the control data bits will be called “data bits.” The encoder 813 encodes the data bits output from the data bit generator 811 in a predetermined encoding technique, and outputs the encoded data bits to the interleaver 815. Here, the encoding technique can be a turbo coding technique, a convolutional coding technique, or other coding techniques having a predetermined coding rate.

The interleaver 815 interleaves the encoded bits output from the encoder 813 in a predetermined interleaving technique, and outputs the interleaved bits to the modulator 817. The modulator 817 modulates the interleaved encoded bits output from the interleaver 815 in a predetermined modulation technique to generate a modulation symbol, and outputs the modulation symbol to the serial-to-parallel converter 819. Here, the modulation technique can be QPSK, 8PSK, 16QAM or 64QAM.

The serial-to-parallel converter 819 parallel-converts the serial modulation symbol output from the modulator 817, and outputs the parallel-converted modulation symbols to the N-IFFT block 821. The N-IFFT block 821 performs the N-IFFT on the signals output from the serial-to-parallel converter 819, and outputs the N-IFFT-processed signals to the parallel-to-serial converter 823. The parallel-to-serial converter 823 serial-converts the signals output from the N-IFFT block 821, and outputs the serial-converted signal to the guard interval inserter 825. The guard interval inserter 825 inserts a guard interval signal into the signal output from the parallel-to-serial converter 823, and outputs the guard interval-inserted signal to the multiplier 860. The guard interval is inserted to remove any interference that occurs between a previous OFDM symbol transmitted at a previous OFDM symbol time and a current OFDM symbol transmitted at a current OFDM symbol time during the transmission of the OFDM symbols in the OFDM communication system. The guard interval is inserted using a cyclic prefix technique or a cyclic postfix technique.

Second, the pilot OFDM symbol generator 850 will be described. The pilot sequence generator 851 generates a pilot sequence uniquely assigned to the base station, and outputs the generated pilot sequence to the serial-to-parallel converter 853. The serial-to-parallel converter 853 parallel-converts the serial pilot sequence output from the pilot sequence generator 851, and outputs the parallel-converted pilot sequence to the N/n-IFFT block 855. The N/n-IFFT block 855 performs the N/n-IFFT on the signal output from the serial-to-parallel converter 853, and outputs the N/n-IFFT-processed signals to the parallel-to-serial converter 857. The parallel-to-serial converter 857 serial-converts the signals output from the N/n-IFFT block 855, and outputs the serial-converted signal to the guard interval inserter 859. The guard interval inserter 859 inserts a guard interval into the signal output from the parallel-to-serial converter 857, and outputs the guard interval-inserted signal to the multiplexer 860.

The multiplexer 860 multiplexes the signal output from the guard interval inserter 825 and the signal output from the guard interval inserter 859, and outputs the multiplexed signal to the digital-to-analog converter 870. The digital-to-analog converter 870 analog-converts the signal output from the multiplexer 860, and outputs the analog-converted signal to the RF processor 880. The RF processor 880, including a filter (not shown) and a front-end unit (not shown), RF-processes the signal output from the digital-to-analog converter 870 such that the signal can be transmitted over the air, and then transmits the RF-processed signal over the air through a transmission antenna.

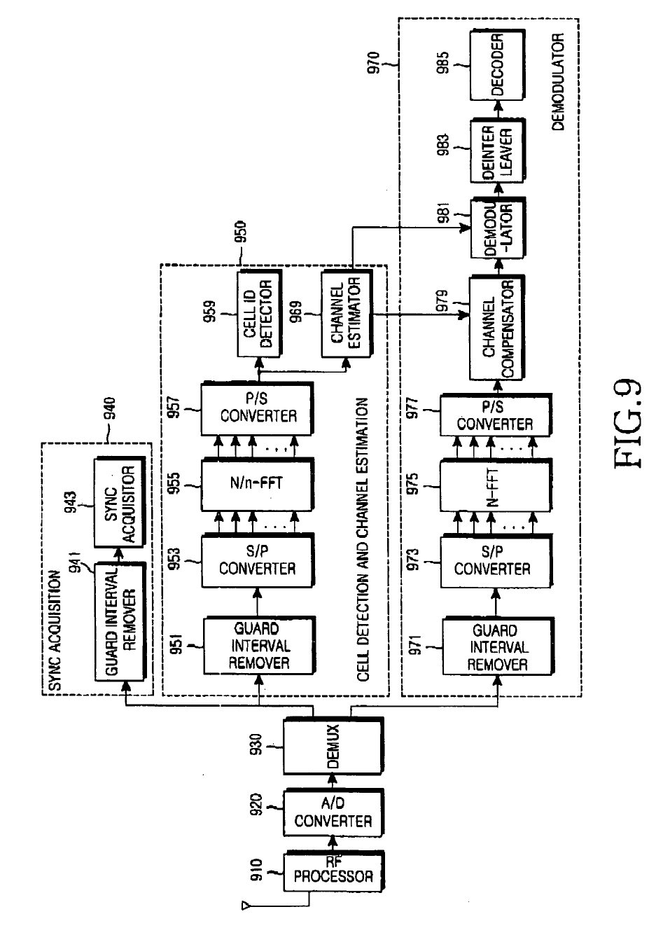

Next, an internal structure of an OFDM reception apparatus according to an embodiment of the present invention will be described with reference to FIG. 9.

FIG. 9 is a block diagram illustrating an internal structure of a first OFDM reception apparatus according to an embodiment of the present invention. Referring to FIG. 9, the OFDM reception apparatus is comprised of an RF processor 910, an analog-to-digital (A/D) converter 920, a demultiplexer (DEMUX) 930, a synchronization acquisition block 940, a base station detection (or cell detection) and channel estimation block 950, and a data demodulator 970. The synchronization acquisition block 940 is comprised of a guard interval remover 941 and a synchronization acquisitor 943. The base station detection and channel estimation block 950 is comprised of a guard interval remover 951, a serial-to-parallel (S/P) converter 953, an N/n-FFT block 955, a parallel-to-serial (P/S) converter 957, a cell identifier (ID) detector 959, and a channel estimator 969. The data demodulator 970 is comprised of a guard interval remover 971, a serial-to-parallel (S/P) converter 973, an N-FFT block 975, a parallel-to-serial (P/S) converter 977, a channel compensator 979, a demodulator 981, a deinterleaver 983, and a decoder 985.

A signal transmitted by a base station is received via a reception antenna of the mobile station apparatus. The signal experiences a multipath fading and has noses added thereto. The signal received via the reception antenna is input to the RF processor 910, and the RF processor 910 down-converts the signal received via the reception antenna into an intermediate frequency (IF) signal, and outputs the IF signal to the analog-to-digital converter 920. The analog-to-digital converter 920 digital-converts an analog signal output from the RF processor 910, and outputs the digital-converted signal to the demultiplexer 930. The demultiplexer 930 demultiplexes the signal output from the analog-to-digital converter 920, and outputs a pilot OFDM symbol to the synchronization acquisition block 940 and the base station detection and channel estimator 950 and outputs a data OFDM symbol to the data demodulator 970.

First, the synchronization acquisition block 940 will be described. A pilot OFDM symbol output from the demultiplexer 930 is input to the guard interval remover 941, and the guard interval remover 941 removes a guard interval from the pilot OFDM symbol output from the demultiplexer 930 and outputs the guard interval-removed pilot OFDM symbol to the synchronization acquisitor 943. The synchronization acquisitor 943 acquires the time synchronization by receiving the signal output from the guard interval remover 941, and acquires the frequency synchronization from a phase difference between the pilot OFDM symbols. Here, the synchronization acquisitor 943, as described above, detects an autocorrelation between a pilot sequence in a previous pilot OFDM symbol period and a pilot sequence in a current pilot OFDM symbol period, acquires the time synchronization when the autocorrelation has a peak value, and acquires the frequency synchronization from a phase difference between the pilot OFDM symbols. Although not illustrated in FIG. 9, the synchronization acquisitor 943 is actually comprised of a correlator and a buffer, so that it can buffer and correlate the pilot symbols in a previous pilot OFDM symbol period and the pilot symbols in a current pilot OFDM symbol period.

Second, the base station detection and channel estimation block 950 will be described. A pilot OFDM symbol output from the demultiplexer 930 is input to the guard interval remover 951, and the guard interval remover 951 removes a guard interval from the pilot OFDM symbol output from the demultiplexer 930, and outputs the guard interval-removed OFDM symbol to the serial-to-parallel converter 953. The serial-to-parallel converter 953 parallel-converts a serial signal output from the guard interval remover 951, and outputs the parallel-converted signals to the N/n-FFT block 955. The N/n-FFT block 955 performs the N/n-FFT on the signals output from the serial-to-parallel converter 953, and outputs the N/n-FFT-processed signals to the parallel-to-serial converter 957. The parallel-to-serial converter 957 serial-converts the parallel signals output from the N/n-FFT block 955, and outputs the serial-converted signal to the cell ID detector 959 and the channel estimator 969.

The cell ID detector 959 detects an ID of a base station (or cell) where the mobile station is located, using a cell ID table previously provided for the cell identification, by receiving the signal output from the parallel-to-serial converter 957. An operation of detecting a cell ID by the cell ID detector 959 will be described in detail herein below. If it is assumed that the number of base stations contained in the OFDM communication system is ‘m’, each of the m base stations is assigned its unique cell ID and a PN sequence mapped to the cell ID. The base station has a cell ID table in which the cell IDs for the m base stations contained in the OFDM communication system and PN sequences mapped to the cell IDs are stored. The cell ID detector 959 receives the signal output from the parallel-to-serial converter 957, sequentially correlates the PN sequences existing in the cell ID table, and detects a cell ID mapped to a PN sequence having a peak value as an ID of a base station where the mobile station is located. The cell ID detector 959, though not illustrated in FIG. 9, is actually comprised of a cell ID table and a correlator. The channel estimator 969 performs the channel estimation on the signal output from the parallel-to-serial converter 957, and outputs the channel estimation result to the channel compensator 979 and the demodulator 981 in the data demodulator 970.

Third, the data demodulator 970 will be described. A pilot OFDM symbol output from the demultiplexer 930 is input to the guard interval remover 971, and the guard interval remover 971 removes a guard interval from the pilot OFDM symbol output from the demultiplexer 930, and outputs the guard interval-removed OFDM symbol to the serial-to-parallel converter 973. The serial-to-parallel converter 973 parallel-converts the serial signal output from the guard interval remover 971, and outputs the parallel-converted signals to the N-FFT block 975. The N-FFT block 975 performs the N-FFT on the signals output from the serial-to-parallel converter 973, and outputs the N-FFT-processed signals to the parallel-to-serial converter 977. The parallel-to serial converter 977 serial-converts the parallel signals output from the N-FFT block 975, and outputs the serial-converted signal to the channel compensator 979. The channel compensator 979 channel-compensates the signal output from the parallel-to-serial converter 977 using the channel estimation result output from the channel estimator 969, and outputs the channel-compensated signal to the demodulator 981. The demodulator 981 demodulates the signal output from the channel compensator 979 using a demodulation technique corresponding to the modulation technique used in the base station, and outputs the demodulated signal to the deinterleaver 983. The deinterleaver 983 deinterleaves the signal output from the demodulator 981 using a deinterleaving technique corresponding to the interleaving technique used in the base station, and outputs the deinterleaved signal the decoder 985. The decoder 985 decodes the signal output from the deinterleaver 983 using a decoding technique corresponding to the coding technique used in the base station, and outputs the decoded signal.

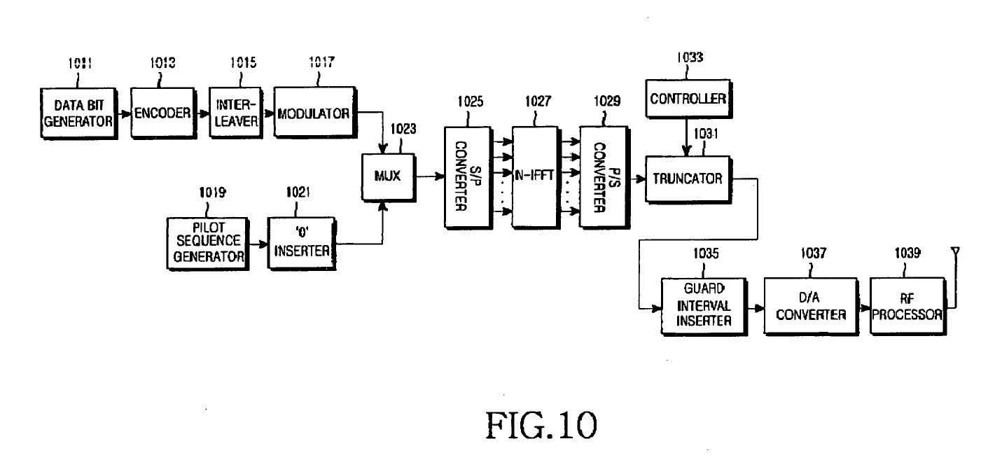

Next, an internal structure of another OFDM transmission apparatus according to an embodiment of the present invention will be described with reference to FIG. 10.

FIG. 10 is a block diagram illustrating an internal structure of a second OFDM transmission apparatus according to an embodiment of the present invention. Before a description of FIG. 10 is given, it is noted that the present invention can selectively use the first OFDM transmission apparatus described in connection with FIG. 8 or the second OFDM transmission apparatus illustrated in FIG. 10. The OFDM transmission apparatus described in connection with FIG. 8, i.e. the first OFDM transmission apparatus, separately includes an IFFT block for a pilot OFDM symbol and an IFFT block for a data OFDM symbol, because the pilot OFDM symbol is different from the data OFDM symbol in the IFFT size. In contrast, the OFDM transmission apparatus illustrated in FIG. 10, i.e. the second OFDM transmission apparatus, includes only one IFFT block even though the pilot OFDM symbol is different from the data OFDM symbol in the IFFT size. The second OFDM transmission apparatus is substantially identical in operation to the first OFDM transmission apparatus except for the IFFT blocks in use.

Referring to FIG. 10, the OFDM transmission apparatus is comprised of a data bit generator 1011, an encoder 1013, an interleaver 1015, a modulator 1017, a pilot sequence generator 1019, a ‘0’ inserter 1021, a multiplexer (MUX) 1023, a serial-to-parallel (S/P) converter 1025, an N-IFFT block 1027, a parallel-to-serial (P/S) converter 1029, a truncator 1031, a controller 1033, a guard interval inserter 1035, a digital-to-analog (D/A) converter 1037, and an RF processor 1039.

The data bit generator 1011 generates data bits to be transmitted, and outputs the generated data bits to the encoder 1013. The encoder 1013 encodes the data bits output from the data bit generator 1011 in a predetermined encoding technique, and outputs the encoded data bits to the interleaver 1015. Here, the encoding technique can be a turbo coding technique, a convolutional coding technique or other coding technique having a predetermined coding rate. The interleaver 1015 interleaves the encoded bits output from the encoder 1013 in a predetermined interleaving technique, and outputs the interleaved bits to the modulator 1017. The modulator 1017 modulates the interleaved bits output from the interleaver 1015 in a predetermined modulation technique to generate a modulation symbol, and outputs the modulation symbol to the multiplexer 1023. Here, the modulation technique can be QPSK, 8PSK, 16QAM or 64QAM.

The pilot sequence generator 1019 generates a pilot sequence uniquely assigned to the base station, and outputs the generated pilot sequence to the ‘0’ inserter 1021. The ‘0’ inserter 1021 inserts ‘0’s in a corresponding position of the signal output from the pilot sequence generator 1019, and outputs the 0-inseted signal to the multiplexer 1023. The reason for inserting ‘0’s into the signal output from the pilot sequence generator 1019 is because the IFFT applied to the pilot OFDM symbol is smaller in size than the IFFT applied to the data OFDM symbol. Therefore, ‘0’s are inserted in order to match the IFFT size applied to the pilot OFDM symbol to the IFFT size applied to the data OFDM symbol. That is, because the IFFT size applied to the pilot OFDM symbol is N/n and the IFFT size applied to the data OFDM symbol is N, ‘0’s are inserted in order to match the IFFT size applied to the pilot OFDM symbol to the IFFT size applied to the data OFDM symbol. In addition, ‘0’s are inserted such that they are inserted between the bits output from the pilot sequence generator 1019.

The multiplexer 1023 multiplexes signals output from the modulator 1017 and the ‘0’ inserter 1021, and outputs the multiplexed signal to the serial-to-parallel converter 1025. The serial-to-parallel converter 1025 parallel-converts the signal signals output from the multiplexer 1023, and outputs the parallel-converted signals to the N-IFFT block 1027. The N-IFFT block 1027 performs an N-IFFT on the signals output from the serial-to-parallel converter 1025, and outputs the N-IFFT-processed signals to the parallel-to-serial converter 1029. The parallel-to-serial converter 1029 serial-converts the signals output from the N-IFFT block 1027, and outputs the serial-converted signal to the truncator 1031. The truncator 1031, under the control of the controller 1033, truncates (n−1) pilot symbols from among the n pilot symbols and outputs the non-truncated symbol to the guard interval inserter 1035, in order to transmit only one pilot symbol from among the n pilot symbols. Here, the reason for truncating (n−1) pilot symbols from among the n pilot symbols is because the pilot OFDM symbol was increased n times in the time domain as the IFFT size applied to the pilot OFDM symbol is identical to the IFFT size applied to the data OFDM symbol. The controller 1033 enables the truncator 1031 only when the signal output from the multiplexer 1023 is a pilot signal. If the signal output from the multiplexer 1023 is not a pilot signal but a data signal, the controller 1033 disables the truncator 1031 so that the signal output from the parallel-to-serial converter 1029 is bypassed to the guard interval inserter 1035.

The guard interval inserter 1035 inserts a guard interval signal into the signal output from the truncator 1031, and outputs the guard interval-inserted signal to the digital-to-analog converter 1037. The digital-to-analog converter 1037 analog-converts the signal output from the guard interval inserter 1035, and outputs the analog-converted signal to the RF processor 1039. The RF processor 1039, including a filter (not shown) and a front-end unit (not shown), RF-processes the signal output from the digital-to-analog converter 1037 such that the signal can be transmitted over the air, and then transmits the RF-processed signal over the air through a transmission antenna.

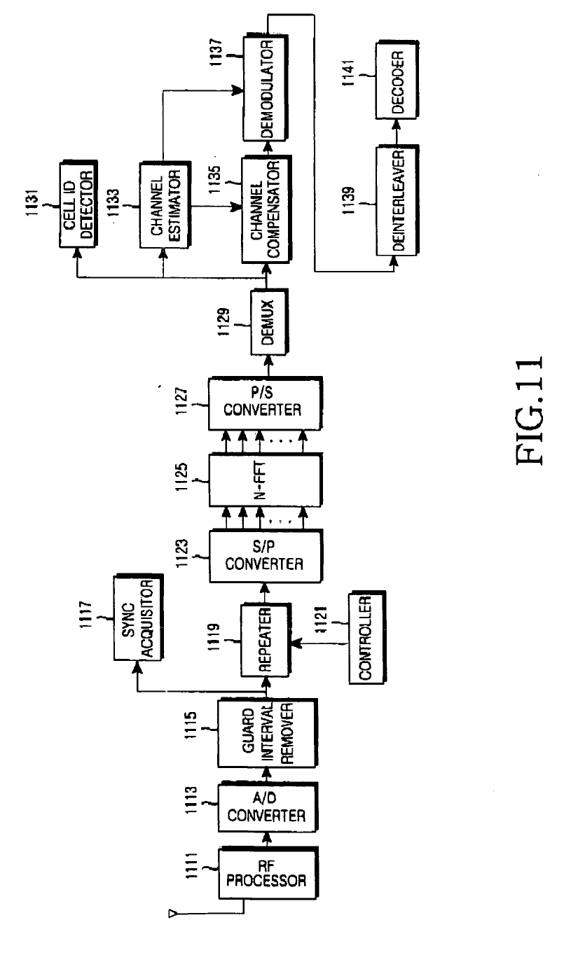

Next, an internal structure of another OFDM reception apparatus according to an embodiment of the present invention will be described with reference to FIG. 11.

FIG. 11 is a block diagram illustrating an internal structure of a second OFDM reception apparatus according to an embodiment of the present invention. Before a description of FIG. 11 is given, it is noted that the present invention can selectively use the first OFDM reception apparatus described in connection with FIG. 9 or the second OFDM reception apparatus illustrated in FIG. 11. The OFDM reception apparatus described in connection with FIG. 9, i.e. the first OFDM reception apparatus, separately includes an FFT block for a pilot OFDM symbol and an FFT block for a data OFDM symbol, because the pilot OFDM symbol is different from the data OFDM symbol in the FFT size. In contrast, the OFDM reception apparatus illustrated in FIG. 11, i.e. the second OFDM reception apparatus, includes only one FFT block even though the pilot OFDM symbol is different from the data OFDM symbol in the FFT size. The second OFDM reception apparatus is substantially identical in operation to the first OFDM reception apparatus except the FFT blocks in use.

Referring to FIG. 11, the OFDM reception apparatus is comprised of an RF processor 1111, an analog-to-digital (A/D) converter 1113, a guard interval remover 1115, a synchronization acquisitor 1117, a repeater 1119, a controller 1121, a serial-to-parallel (S/P) converter 1123, an N-FFT block 1125, a parallel-to-serial (P/S) converter 1127, a demultiplexer (DEMUX) 1129, a cell ID detector 1131, a channel estimator 1133, a channel compensator 1135, a demodulator 1137, a deinterleaver 1139, and a decoder 1141.

A signal transmitted by a base station is received via a reception antenna of the mobile station apparatus. after the signal experiences multipath fading and has noses added thereto. The signal received via the reception antenna is input to the RF processor 1111, and the RF processor 1111 down-converts the signal received via the reception antenna into an IF signal, and outputs the IF signal to the analog-to-digital converter 1113. The analog-to-digital converter 1113 digital-converts an analog signal output from the RF processor 1111, and outputs the digital-converted signal to the guard interval remover 1115. The guard interval remover 1115 removes a guard interval from the signal output from the analog-to-digital converter 1113, and outputs the guard interval-removed signal to the synchronization acquisitor 1117, and the repeater 1119.

The synchronization acquisitor 1117 acquires the time synchronization by receiving the signal output from the guard interval remover 1115, and acquires the frequency synchronization from a phase difference between the pilot OFDM symbols. Here, the synchronization acquisitor 1117, as described above, detects an autocorrelation between a pilot sequence in a previous pilot OFDM symbol period and a pilot sequence in a current pilot OFDM symbol period, acquires the time synchronization when the autocorrelation has a peak value, and acquires the frequency synchronization from a phase difference between the pilot OFDM symbols. Although not illustrated in FIG. 11, the synchronization acquisitor 1117 is actually comprised of a correlator and a buffer, so that it can buffer and correlate the pilot signals in a previous pilot OFDM symbol period and the pilot signals in a current pilot OFDM symbol period.

The repeater 1119 repeats the signal output from the guard interval remover 1115 under the control of the controller 1121, and outputs the repeated signal to the serial-to-parallel converter 1123. Here, the reason for repeating the signal output from the guard interval remover 1115 by the repeater 1119 is to match the size of the pilot OFDM symbol to the size of the data OFDM symbol because the size of the pilot OFDM symbol is different from the size of the data OFDM symbol. The controller 1121 enables the repeater 1119 only when the signal output from the guard interval remover 1115 is a pilot signal. If the signal output from the guard interval remover 1115 is not a pilot signal but a data signal, the controller 1121 disables the repeater 1119 so that the signal output from the guard interval remover 1115 is bypassed to the serial-to-parallel converter 1123.

The serial-to-parallel converter 1123 parallel-converts a serial signal output from the repeater 1119, and outputs the parallel-converted signals to the N-FFT block 1125 . The N-FFT block 1125 performs an N-FFT on the signals output from the serial-to-parallel converter 1123, and outputs the N-FFT-processed signals to the parallel-to-serial converter 1127. The parallel-to-serial converter 1127 serial-converts the parallel signals output from the N-FFT block 1125, and outputs the serial-converted signal to the demultiplexer 1129. The demultiplexer 1129 demultiplexes the signal output from the parallel-to-serial converter 1127, outputs the pilot signal to the cell ID detector 1131 and the channel estimator 1133 and outputs the data signal to the channel compensator 1135.

The cell ID detector 1131 detects an ID of a base station (or cell) where the mobile station is located, using a cell ID table previously provided for the cell identification. An operation of detecting a cell ID by the cell ID detector 1131 is identical to the operation of detecting a cell ID by the cell ID detector 959 described in connection with FIG. 9, so a detailed description thereof will be omitted herein.

The channel estimator 1133 performs the channel estimation on the signal output from the demultiplexer 1129, and outputs the channel estimation result to the channel compensator 1135 and the demodulator 1137 . The channel compensator 1135 channel-compensates the signal output from the demultiplexer 1129 using the channel estimation result output from the channel estimator 1133, and outputs the channel-compensated signal to the demodulator 1137. The demodulator 1137 demodulates the signal output from the channel compensator 1135 in a demodulation technique corresponding to the modulation technique used in the base station, and outputs the demodulated signal to the deinterleaver 1139. The deinterleaver 1139 deinterleaves the signal output from the demodulator 1137 in a deinterleaving technique corresponding to the interleaving technique used in the base station, and outputs the deinterleaved signal the decoder 1141. The decoder 1141 decodes the signal output from the deinterleaver 1139 in a decoding technique corresponding to the coding technique used in the base station, and outputs the decoded signal.

As can be appreciated from the foregoing description, the OFDM communication system employing the pilot symbol technique according to the present invention differentiates an IFFT/FFT size applied to a pilot OFDM symbol from an IFFT/FFT size applied to a data OFDM symbol, thereby minimizing the pilot overhead caused by the pilot symbols. In addition, the use of the pilot symbol technique facilitates the time and frequency acquisition, and secures the correct cell identification, the channel estimation and the CQI measurement, and the differentiated IFFT/FFT sizes minimize the pilot overhead, thereby maximizing the system efficiency of the OFDM communication system.

While the invention has been shown and described with reference to a certain preferred embodiment thereof, it will be understood by those skilled in the art that various changes in form and details may be made therein without departing from the spirit and scope of the invention as defined by the appended claims.

1. A method for transmitting a reference signal in a transmitter of a radio communication system which divides an entire frequency band into a plurality of subcarrier bands, forms a symbol from signals on the subcarrier bands, forms a frame from a plurality of symbols, transmits the reference signal within symbols in a predetermined position of the frame, and transmits a data signal within symbols other than the symbols for transmitting the reference signal, the method comprising the steps of:
performing an inverse fast Fourier transform (IFFT) on a reference signal by applying an IFFT size which is less than an IFFT size applied to the data signal; and
transmitting the IFFT-processed reference signal to a receiver.

2. The method of claim 1, wherein the reference signal is a pilot signal.

3. The method of claim 1, wherein the IFFT size represents the number of input points of an IFFT block.

4. A method for receiving a reference signal in a receiver of a radio communication system which divides an entire frequency band into a plurality of subcarrier bands, forms a symbol from signals on the subcarrier bands, forms a frame from a plurality of symbols, transmits the reference signal within symbols in a predetermined position of the frame, and transmits a data signal within symbols other than the symbols for transmitting the reference signal, the method comprising the steps of:
receiving a signal and detecting a reference signal from the received signal; and
performing a fast Fourier transform (FFT) on the reference signal by applying an FFT size which is less than an FFT size applied to the data signal.

5. The method of claim 4, wherein the reference signal is a pilot signal.

6. The method of claim 4, wherein the FFT size represents the number of input points of an FFT block.

7. A method for transmitting a signal in a transmitter of a radio communication system which divides an entire frequency band into a plurality of subcarrier bands, forms a from signals on the subcarrier bands, forms a frame from a plurality of symbols, transmits a reference signal within symbols in a predetermined position of the frame, and transmits a data signal within symbols other than the symbols for transmitting the reference signal, the method comprising the steps of:
performing an inverse fast Fourier transform (IFFT) on a data signal according to a first IFFT size;
performing an IFFT on a reference signal according to a second IFFT size which is less than the first IFFT size;
multiplexing the IFFT-processed data signal and the IFFT-processed reference signal; and
transmitting the multiplexed signal to a receiver.

8. The method of claim 7, wherein the reference signal is a pilot signal.

9. A method for receiving a signal in a receiver of a radio communication system which divides an entire frequency band into a plurality of subcarrier bands, forms a symbol from signals on the subcarrier bands, forms a frame from a plurality of symbols, transmits a reference signal within symbols in a predetermined position of the frame, and transmits a data signal within symbols other than the symbols for transmitting the reference signal, the method comprising the steps of:
demultiplexing a received signal into a reference signal and a data signal;
performing a fast Fourier transform (FFT) on the data signal according to a first FFT size; and
performing a FFT on the reference signal according to a second FFT size which is less than the first FFT size.

10. The method of claim 9, wherein the reference signal is a pilot signal.

11. An apparatus for transmitting a reference signal in a transmitter of a radio communication system which divides an entire frequency band into a plurality of subcarrier bands, forms a symbol from signals on the subcarrier bands, forms a frame from a plurality of symbols, transmits the reference signal within symbols in a predetermined position of the frame, and transmits a data signal within symbols other than the symbols for transmitting the reference signal, the apparatus comprising:
an inverse fast Fourier transform (IFFT) module for receiving a reference signal and performing an IFFT on the reference signal by applying an IFFT size which is less than an IFFT size applied to a data signal; and
a transmitter for transmitting the IFFT-processed reference signal to a receiver.

12. The apparatus of claim 11, wherein the reference signal is a pilot signal.

13. The apparatus of claim 11, wherein the IFFT size represents the number of input points of an IFFT block.

14. An apparatus for receiving a reference signal in a receiver of a radio communication system which divides an entire frequency band into a plurality of subcarrier bands, forms a symbol from signals on the subcarrier bands, forms a frame from a plurality of symbols, transmits the reference signal within symbols in a predetermined position of the frame, and transmits a data signal within symbols other than the symbols for transmitting the reference signal, the apparatus comprising:
a receiver for receiving a signal and detecting a reference signal from the received signal; and
a fast Fourier transform (FFT) module for performing FFT on the reference signal by applying an FFT size which is less than an FFT size applied to the data signal.

15. The apparatus of claim 14, wherein the reference signal is a pilot signal.

16. The apparatus of claim 14, wherein the FFT size represents the number of input points of an FFT block.

17. An apparatus for transmitting a signal in a transmitter of a radio communication system which divides an entire frequency band into a plurality of subcarrier bands, forms a symbol from signals on the subcarrier bands, forms a frame from a plurality of symbols, transmits a reference signal within symbols in a predetermined position of the frame, and transmits a data signal within symbols other than the symbols for transmitting the reference signal, the apparatus comprising:
a first inverse fast Fourier transform (IFFT) module for performing an IFFT on a data signal according to a first IFFT size;
a second IFFT module for performing an IFFT on a reference signal according to a second IFFT size which is less than the first IFFT size; and
a transmitter for multiplexing the IFFT-processed data signal and the IFFT-processed reference signal, and transmitting the multiplexed signal to a receiver.

18. The apparatus of claim 17, wherein the reference signal is a pilot signal.

19. An apparatus for transmitting a signal in a transmitter of a radio communication system which divides an entire frequency band into a plurality of subcarrier bands, forms a symbol from signals on the subcarrier bands, forms a frame from a plurality of symbols, transmits a reference signal within symbols in a predetermined position of the frame, and transmits a data signal within symbols other than the symbols for transmitting the reference signal, the apparatus comprising:
a ‘0’ inserter for inserting ‘0’s in predetermined positions of a reference signal;
a multiplexer for multiplexing a data signal and the ‘0’-inserted reference signal;
an inverse fast Fourier transform (IFFT) module for performing an IFFT on the multiplexed data signal and ‘0’ -inserted reference signal;
a truncator for one of truncating the IFFT-processed signal before outputting and outputting the IFFT-processde signal without truncation, according to a control signal; and
a transmitter for transmitting a signal output from the truncator to a receiver.

20. The apparatus of claim 19, further comprising a controller for controlling the truncator to truncate the IFFT-processed signal before outputting if the IFFT-processed signal is a reference signal, and to output the IFFT-processed signal without truncation if the IFFT-processed signal is a data signal.

21. The apparatus of claim 19, wherein the reference signal is a pilot signal.

22. An apparatus for receiving a signal in a receiver of a radio communication system which divides an entire frequency band into a plurality of subcarrier bands, forms a symbol from signals on the subcarrier bands, forms a frame from a plurality of symbols, transmits a reference signal within symbols in a predetermined position of the frame, and transmits a data signal within symbols other than the symbols for transmitting the reference signal, the apparatus comprising:
a demultiplexer for demultiplexing a received signal into a reference signal and a data signal;
a first fast Fourier transform (FFT) module for performing a FFT on the data signal according to a first FFT size; and
a second FFT module for performing a FFT on the reference signal according to a second FFT size which is less than the first FFT size.

23. The apparatus of claim 22, wherein the reference signal is a pilot signal.

24. An apparatus for receiving a signal in a receiver of a radio communication system which divides an entire frequency band into a plurality of subcarrier bands, forms a symbol from signals on the subcarrier bands, forms a frame from a plurality of symbols, transmits a reference signal within symbols in a predetermined position of the frame, and transmits a data signal within symbols other than the symbols for transmitting the reference signal, the apparatus comprising:
a repeater for one of repeating a received signal before outputting and outputting the received signal without repetition, according to a control signal;
a fast Fourier transform (FFT) module for performing a FFT on a signal output from the repeater; and
a demultiplexer for demultiplexing the FFT-processed signal into a reference signal and a data signal.

25. The apparatus of claim 24, further comprising a controller for controlling the repeater to repeat the received signal before outputting if the received signal is a reference signal, and to output the received signal without repetition if the received signal is a data signal.

26. The apparatus of claim 24, wherein the reference signal is a pilot signal.

27. A method for generating a frame in an Orthogonal Frequency Division Multiplexing (OFDM) communication system including a first inverse fast Fourier transform (IFFT) module for generating a reference symbol in a time domain by receiving a reference signal in a frequency domain through input points, and a second IFFT module for generating a data symbol in a time domain by receiving a data signal in a frequency domain, comprising the steps of:
providing one reference symbol in a time domain every predetermined number of data symbols generated from the second IFFT module,
wherein a time duration of the reference symbol is defined as a ratio of the number of input points of the first IFFT module to a number of input points of the second IFFT module when a time duration of each data symbol is set to ‘1’.

28. The method of claim 27, wherein the number of input points of the first IFFT block is less than the number of input points of the second IFFT block.

29. The method of claim 27, wherein the reference signal is a pilot signal.

30. A method for transmitting a signal in a transmitter of a radio communication system which divides an entire frequency band into a plurality of subcarrier bands, forms a symbol from signals on the subcarrier bands, forms a frame from a plurality of symbols, transmits a reference signal within symbols in a predetermined position of the frame, and transmits a data signal within symbols other than the symbols for transmitting the reference signal, the method comprising the steps of:
inserting ‘0’s in predetermined positions of a reference signal;
multiplexing a data signal and the ‘0’-inserted reference signal;
performing an Inverse Fast Fourier transform (IFFT) on the multiplexed data signal and the ‘0’-inserted reference signal;
performing a truncation of the IFFT-performed signal if the IFFT-performed signal is the reference signal; and
transmitting the truncation-performed signal.

31. A method for receiving a signal in a receiver of a radio communication system which divides an entire frequency band into a plurality of subcarrier bands, forms a symbol from signals on the subcarrier bands, forms a frame from a plurality of symbols, transmits a reference signal within symbols in a predetermined position of the frame, and transmits a data signal within symbols other than the symbols for transmitting the reference signal, the method comprising the steps of:
performing a repetition of a received signal if the received signal is a reference signal;
performing a Fast Fourier transform (FFT) on the repetition-performed signal.
